(19) United States
(12) Patent Application Publication
(10) Pub. No.: US 2015/0091341 A1
(43) Pub. Date: Apr. 2, 2015

(54) SEATING DEVICE

(71) Applicant: BUCKLEY William James, (US)

(72) Inventor: William James Buckley, Kinvara (IE)

(21) Appl. No.: 14/381,414

(22) PCT Filed: Mar. 1, 2013
(86) PCT No.: PCT/EP2013/054215

§ 371 Date: Aug. 27, 2014

(30) Foreign Application Priority Data
Mar. 1, 2012 (EP) 12157791.0

(51) Int. Cl. A47C 3/00; A47C 4/54; A47C 17/34; B68G 7/00

(52) U.S. Cl. CPC A47C 3/00; B68G 7/00; A47C 4/54; A47C 17/34
USPC 297/183.1; 29/91.1; 297/452.1; 297/452.48; 297/452.41; 297/232

(57) ABSTRACT

A device suitable for sitting or reclining, the device including a base portion having upper and lower surfaces and at least one depression which extends into at least the upper surface of the base thereof; and a body portion having at least one surface region adapted to be received within the depression of the base; wherein the diameter of the body is greater than the diameter of the depression, such that the body projects beyond at least the upper surface of the base, such that the body is supported by the base.

### FIELD OF THE INVENTION

The invention relates to device for sitting or reclining. In particular, to a sitting or reclining device which encourages the user to sit utilizing a neutral posture. The device therefore offers benefits such as optimizing a user's breathing, circulation and neurological performance.

### DESCRIPTION OF RELATED ART

The human body is not designed to sit in static positions. However human beings need to rest and work to survive in the contemporary environment. People sit on chairs to rest themselves, legs and feet. However, resting weight on static surfaces can obstruct the flow of the human being. The human body's respiratory, neurological and circulatory systems must flow to function correctly.

Great strides in ergonomic design (human to machine interface) have been made to improve the static model to be better fitting, more adjustable and more comfortable by increasing supports and promoting the neutral posture. Existing seat or chair designs appear to be engineered for static humans or humans that have static bodies that can conform to the seat/chair they interface with.

However, there is always need for further improvements to ensure encouragement of optimal comfort, strength and bodily function.

### OBJECT OF THE INVENTION

An object of the present invention is provide a device suitable for seating or reclining and which offers the user dynamic seating or reclining support which encourages the user to adopt an optimal body neutral seating or reclining position.

It is a further object of the invention to offer the user muscle relief and skeletal alignment while using the device.

It is a further object of the invention to offer the user full natural breathing while using the device.

It is a further object to optimize users passive caloric burn rate while using the device.

It is a further object to optimize central and automatic nervous systems while using the device.

### SUMMARY OF THE INVENTION

According to a first aspect of the present invention, as set out in the appended claims, there is provided a device suitable for sitting or reclining, the device comprising:

a base portion having upper and lower surfaces and at least one depression which extends into at least the upper surface of the base thereof; and

a body portion having at least one surface region adapted to be received within the depression of the base;

wherein the diameter of the body is greater than the diameter of the depression, such that the body projects beyond at least the upper surface of the base, such that the body is supported by the base.

In a preferred embodiment, the device further comprises a head portion having upper and lower surfaces and at least one depression which extends into at least the lower surface of the head thereof;

wherein the body portion has at least one second surface region adapted to be received within the depression of the head;

wherein the diameter of the body is greater than the diameter of the depression, such that the body projects beyond at least the lower surface of the head, such that the head is supported by the body.

Preferably, the device further comprising means for limit relative movement of the above mentioned portions, thereby stabilizing the device, such that a user may sit or lay thereon comfortably and safely. In one embodiment, the means may be a strap or band secured about the head and base portions of the device to hold the portions in close contact. In a preferred embodiment, means for limit relative movement of the above mentioned portion may be a cover for encapsulating the device, wherein the cover is arranged to limit relative movement of the above mentioned portions, thereby stabilizing the device, such that a user may sit or lay thereon. The cover may be secured by use of Velcro, zippers or other fastening means known to the skilled person.

In a further preferred embodiment, a stabilizing base may be provided, wherein the stabilizing base has an orifice located therein in which the device of the invention may be accommodated, wherein the diameter of the device of the invention is substantially the same as the diameter of the orifice of the stabilizing base, so that the device may sit snugly within the orifice for additional support.

In a second aspect of the invention, there is provided a process for manufacturing a device for seating or reclining, the process comprising:

providing a base portion having upper and lower surfaces and at least one depression which extends into at least the upper surface of the base thereof; and

supporting a body portion onto the base portion,

wherein the body portion has at least one surface region adapted to be received within the depression of the base, wherein the diameter of the body is greater than the diameter of the depression, such that the body projects beyond at least the upper surface of the base, such that the body is supported by the base.

In a preferred embodiment, the process further comprises supporting a head portion onto the body portion,

wherein the head portion has upper and lower surfaces and at least one depression which extends into at least the lower surface of the head thereof; and the body portion having at least one second surface region adapted to be received within the depression of the head, wherein the diameter of the body is greater than the diameter of the depression, such that the body projects beyond at least the lower surface of the head, such that the head is supported by the body.

In a preferred embodiment, the process further comprises for encapsulating the device with a cover for limiting relative movement of the above-mentioned portions, thereby stabilizing the device, such that a user may sit or lay thereon. The cover may be provided with any desired decoration, texture, colour, etc., for aesthetic purposed.

Desirably, the base may be circular or cylindrical ring shaped, square ring shaped, triangular ring shaped or serpentine ring shaped. Most preferably still, the base may be a pipe shaped ring or a tubular shaped ring, or other ring shape having a suitable depressions for accommodating the body portion.

Most preferably, the head may be circular or cylindrical ring shaped, square ring shaped, triangular ring shaped or serpentine ring shaped. Most preferably still, the head may be a pipe shaped ring or a tubular shaped ring, or other ring shape having a suitable depressions for accommodating the body portion.

Desirably the body may be sphere shaped, dumbbell shaped, square shaped, pyramid shaped, circular or cylindrical ring shaped, square ring shaped, triangular ring shaped or serpentine ring shaped, or other suitable shape having portions which may be accommodated within the depression of the head and base portions. In a preferred embodiment, the body portion may be an exercise ball or a physio roll.

In a preferred embodiment, the depression is a groove or is groove shaped to provide an indentation into the base or head portion of the device.

In another preferred embodiment, the depression may extend through the upper and lower surfaces of the base to form an orifice therein.

In a preferred embodiment still, the device the depression may extend through the upper and lower surfaces of the head forming an orifice therein.

Suitably, the orifice may be disposed centrally within the base and/or the head.

In a preferred embodiment the head, base and/or body may be made of an elastic material. Examples of suitable materials include anti burst plastic, rubber, polyurethane, thermoplastic polymer, high tenacity yarn, elastic polymer, silicon, thermoplatic, thermoset, and vulcanisates.

In a particularly preferred embodiment, at least one of the base, head and/or body may be hollow. Most preferably, each of the base, head and/or body is hollow.

More preferably still at least one of the hollow head, base and/or body is inflatable and comprise a valve means for inflation. Most preferably, each of the base, head and/or body is inflatable. Any suitable fluid, such as a liquid, gas or compressed gas may be used to inflate the portions of the device of the invention. Air is particularly preferred as it is readily accessible and inexpensive to supply.

Desirably, the inflatable head, base and/or body is air tight, so that the user does not have to frequently inflate the portions of the device.

Suitably, the cover is made from an airtight or air permeable material. Suitably, the cover is made of an air permeable material, as when in use, the action of the user sitting or reclining on the device will expel air through the cover to provide a more comfortable position.

In a particularly preferred embodiment, the device further comprises at least one handle to facilitate moving, relocating or storing the device. Suitably, the handle may be disposed on at least one location of the cover of the device of the invention.

In a related aspect, the device of the invention may be laid on its side and the side portion used for sitting or reclining. In particular, more than one device may be laid on it side in a row to provide an arrangement where the devices form an extended area for the user to recline thereon. Means for securing the devices in this configuration are described above and include straps or covers.

In a preferred embodiment, there is provided a kit of parts comprising at least two of the items of the group consisting of: a base portion of the device of the invention, a body portion of the device of the invention, a head portion of the device of the invention, instructions for use, a pump, valves, a cover and straps.

In a particularly preferred embodiment, there is provided a device for seating or reclining comprising:

two or more chambers arranged in use to form a substantially rigid body;

wherein a first chamber is ring shaped base having a orifice disposed substantially centrally therein;

wherein a second chamber is substantially spherical and has a diameter greater than the diameter of the inner orifice of the first chamber,

such that, in use, the second chamber rests on top of the ring shaped chamber and a portion of the second chamber is accommodated within the central orifice of the first chamber, thereby providing a stable configuration.

In a preferred embodiment, there is provided a third chamber comprising a ring shaped head having a orifice disposed substantially centrally therein for mounting on top of the second chamber to provide a seating or reclining surface, wherein the diameter of the inner orifice of the third chamber is less than the diameter of the second chamber.

Desirably, the chambers are adapted to be inflated by a fluid, for example, a liquid or gas. Suitably, at least one of the ring shaped base and the ring shaped head may be circular or cylindrical ring shaped, square ring shaped, triangular ring shaped or serpentine ring shaped. Desirably the substantially spherical body may be sphere shaped, dumbbell shaped, square shaped, pyramid shaped, circular or cylindrical ring shaped, square ring shaped, triangular ring shaped or serpentine ring shaped. Preferably, the body is spherical or dumbbell shaped.

A further aspect of the invention provides for a device suitable for sitting or reclining, the device comprising an inflatable head, body and base portion such that when the device is inflated, the head portion is further foldable in the direction of the base to reduce the vertical dimension of the device.

This provides the advantage of allowing the user to adjust the height of the device to their preference.

The head, body and base portion may be integrally formed. The head, body and base portion may be formed from a single piece of air tight material. This provides the advantage of straightforward and cost effective fabrication.

The head, body and base portions may comprise a plurality of interconnected chambers. This allows for ease of inflation by the user and control of inflation to achieve a desired pressure within the device.

When the device is uninflated, the device may be dimensioned to be 500 ml or less in volume. This allows for a fully deflated device to be easily carried by a user.

The device of the invention is known as the AerChair™ or an “Intentionally Dynamic Support Device™”.

### BRIEF DESCRIPTION OF THE DRAWINGS

The invention will be more clearly understood from the following description of preferred embodiments of the invention, given by way of example only, with reference to the accompanying drawings, in which:—

FIG. 1 illustrates a 1 Base covered tube, a Physio Roll and a Sphere. The 1 Base covered tube is used with the AerChair to add uniqueness to appearance while providing optional comfort and stability. 1 Base is constructed from the Base tube cover (3 panels 2 zippers)×1 and the Base Tube 1 (Inflatable Inner Tube 135/145 TR13) and air. The Physio Roll Shape and Sphere are the primary form of the body chambers as described above.

FIG. 2 illustrates a B20 model; the B20 is a cover surrounding the Small Tube 3.5-6× supporting the Blue 20 CM diameter Sphere beneath one Medium Tube 400×8.00, each end of the cover has a handle and an opening sealable via velcro or zipper.

FIG. 3 illustrates a G25 model; the G25 is a cover surrounding the Small Tube 3.5-6× supporting the Green 25 CM diameter Sphere beneath one Medium Tube 400×8.00 each end of the cover has a handle and an opening sealable via velcro or zipper.

FIG. 4 illustrates a P35 model; the P35 is a cover surrounding the Small Tube 3.5-6× supporting the Pink 35 CM Diameter Sphere beneath one Medium Tube 400×8.00 surrounded by a cover, each end of the cover has a handle and an opening sealable via velcro or zipper.

FIG. 5 illustrates a P35+1 model; the P35+1 is a cover surrounding the Small Tube 3.5-6× supporting the Pink 35 CM Diameter Sphere beneath two Medium Tube 400×8.00 surrounded by a cover, each end of the cover has a handle and an opening sealable via velcro or zipper.

FIG. 6 illustrates a B50 model; the B50 is a base tube with regular cover supporting a cover surrounding one Small Tube 3.5-6× supporting the Red 65 CM Physio Roll beneath 1 Medium Tube 400×8.00, each end of the cover has a handle and an opening sealable via velcro or zipper.

FIG. 7 illustrates a R65 model; the R65 is a base tube with cover supporting the Large cover size of this design surrounding one Small Tube 3.5-6× supporting the Red 65 CM Physio Roll beneath one Medium Tube 400×8.00, each end of the cover has a handle and an opening sealable via velcro or zipper.

FIG. 8 illustrates a R65+1 model; the R65+1 is a base tube with cover supporting the second largest cover of this design, surrounding a Small Tube 3.5-6× which is supporting the Red 65 CM Physio Roll beneath two Medium Tubes 400×8.00, each end of the cover has a handle and an opening sealable via velcro or zipper.

FIG. 9 illustrates a Design 16 model; The Design 16 is a cover with handles and openings controlled by zippers or velcro at each end. Inside the cover is a inflatable rubber tyre inner tube 4.00×8 (D1 32 d2 8) supporting either a Blue 50 Physio Roll (50 CM by 35 CM and 35 CM) or Red 65 physio roll (65 CM by 40 CM and 40 CM) or 20 CM, 25 CM 35 CM diameter spheres supporting another inflatable rubber tyre inner tube 4.00×8 (D1 32 d2 8).

FIG. 10 illustrates a Design 19 model; the Design 19 is a cover with handles and openings controlled by zippers or velcro at each end. Inside the cover is a inflatable rubber tyre inner tube 135/145 TR13 supporting 20 CM, 25 CM35 CM, 50 CM, 60 CM, 70 CM, and 80 CM diameter spheres supporting another inflatable rubber tyre inner tube 4.00×8 (D1 32 d2 8).

FIGS. 11 A and B illustrates a FMCG Gathering model. The FMCG Gathering is an inflatable device comprising body with foldable head portion and rectangular base portion.

FIGS. 12 A, B and C illustrate a side, top and front view respectively of an FMCG 4.4 model. The FMCG is an inflatable device comprising multiple air chambers

FIGS. 13 A and B illustrate an external view of the FMCG 4.4 model and a cross section of the model.

### DETAILED DESCRIPTION OF THE INVENTION

The seating device of the invention is a type of personal inertia optimization system and utilizes seating or reclining support platforms to promote neutral posture and facilitate skeletal, neurological, tissue and circulatory flow and alignment.

Users experience optimized oxygen intake, core abdominal muscle exercise, reduced stress on the muscular system, and optimization of the neurological system. Furthermore, the device of the invention helps users lose weight, improve core abdominal muscle strength, increase their mental productivity, promote happiness and feelings of well being.

The dynamic support comes from the user's bio mass conducted through air particles integrated with elastic, breathable and sealed boundaries governed by valves, seams, zippers and velcro. The integration of the breathable and air tight and chambers, whereas as least one is a self contained tube. A non airtight chamber bound by an elastic self contained circular tube wall. Only upholstered multi cell inflatable chair, bench or bed. Only intentionally Dynamic Support personal platform and the dynamism comes from the air pressure in the self contained inflatable tubes as they relate to the user's personal body mass versus the combined mass of the air, the containers and earth. Near balance occurs only when the user relaxes in a balanced posture Users find by focusing their conscious mental attention to the breath as it enters and exits each nasal passage they acquire a sense of buoyancy and balance while muscles become increasingly relaxed. By relaxed breathing and sharp mental consciousness their biomass integrates and interfaces with the support provided by the air particles bound by the containers.

The seating or reclining device of the invention can be used by itself, or with its accessory ring or multiple seating or reclining device of the inventions can be used congruously to provide muscle relief and skeletal alignment by encouraging the user to adopt a neutral body position. A neutral body position is a posture in which the joints are not bent and the spine is aligned and not twisted. In the regular position, that is vertically erect, a user can sit on the device of the invention and can settle to a relaxed neutral body posture that resembles their posture in zero gravity. This neutral posture provides unobstructed bodily circuits and enables a full and natural breath and expansion of the core abdominal muscles. This ensures that the user's body gets the optimum amount of oxygen for circulated throughout the body. Furthermore, the unobstructed abdominal motion increases the passive caloric burn rate of the user while strengthening their abdomen at the same time. The user's metabolism becomes less obstructed. The circulatory and nervous systems flow unobstructed. Once the obstructions are removed, the body is facilitated in healing itself.

Furthermore, neutral posture enables the human being to be completely conscious of their own personal body mass, balance, proportion and inertia. Neutral posture optimizes breathing, circulation of body fluids and neurological performance.

The seating or reclining device of the invention is a new device class of furniture. The seating or reclining device of the invention is built upon the dynamic support of air located in a combination of air tight chambers and non air tight chambers which are allow to have a controlled degree of relative motion with respect to each other. The torsional and linear rigidity imposed by the interdependent arrangement of the invention provide adjustment of the user's inertia to a stable relaxed position that enables unobstructed breathing, unobstructed flow of bodily fluids and an unobstructed nervous system via enforcing an improved fluid and dynamic neutral posture performance.

Critically, the support provided to the user by the seating or reclining device of the invention is not static, so the sitting is not sitting in its generally accepted form. The support offered by the device of the invention is dynamic and arises from a compromise between the user's inertia on the device against the inherent inertia of the combination of air, the components of the seating or reclining device of the invention, and gravity. The requirement for personal inertia management facilitates the development of a sense of personal buoyancy when using the device of the invention.

The seating or reclining device of the preferred embodiments of the invention has been developed around the principle of dynamic support arising from the particular arrangement of inflated airtight internal components which are bound by non-rigid walls in all directions. The key airtight component is bound by at least two base and head components at each end and held in a low stability configuration by a durable cover.

The device of the invention is an attractive cover surrounding a minimum of one elastic non rigid chambers of air used as a platform to place the human posterior upon to enable the user to actively engage with their surroundings while optimizing the inertia of the human body through mindful activity.

The preferred choice of covers is commercial contract grade upholstery. The first production models are black leatherette, green and red anti stain fabric. Waterproof fabrics are useful for cleaning purposes.

Initially four sizes were produced—Full size 70 cm tall by 38 cm in diameter, Regular 60 cm by 38 cm in diameter, Junior is 33 cm by 33 cm in diameter, and Prodigy is 30 cm by 33 cm in diameter.

The fifth size is still being engineered for manufacturing with a target height of 45 cm by 38 cm in diameter. Preferably three bladders inside the cover are 2 inflatable tyre inner tubes and one exercise ball or physio roll. The intentionally dynamic support device is an attractive cover surrounding a minimum of one elastic non rigid chambers of air used as a platform to place the human posterior upon to enable the user to actively engage with their surroundings while optimizing the inertia of the human body through mindful activity.

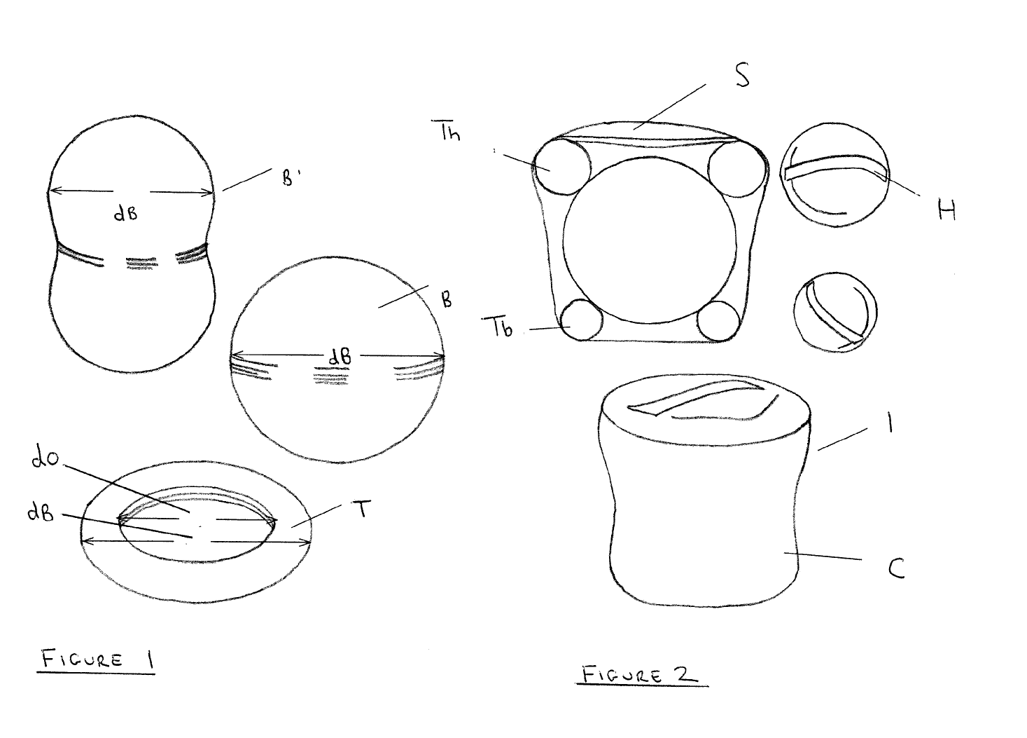

The Tables below and FIGS. 1 to 10 illustrate and describe the preferred components and samples of assembled seating or reclining device of the invention. The covers are referred to as covers and the base and head portions are referred as tubes. The first letter refers to the color of the key inflated body portion; i.e. G=green, B=blue, P=pink, R=red. Description adds clarity to the name. Dimensions are used for design consideration and are elastic. The end covers are the same dimensions for all models.

| Name | Description | Dimensions |
|---|---|---|
| Small Tube 3.5-6 | Inflatable inner tube kings Tire 3.50-6.00 | D1 23 d2 7 |
| Medium tube 400 × | Inflatable inner tube D1 32 d2 8 | D1 32 d2 8 |
| 8.00 | | |
| Base Tube 1 | Inflatable Inner Tube 135/145 TR13 | D1 53 d2 10 |
| Blue 20 Ball | Blue Exercise Ball 20 CM diameter | 20 CM diameter |
| | | Sphere |
| Green 25 Ball | Green Exercise Ball 25 CM diameter | 25 CM Diameter |
| | | Sphere |
| Pink 38 Ball | Pink Exercise Ball 38 CM Dimension | 38 CM Diameter |
| | | Sphere |
| Main Blue Med | Blue Physio Roll 50 CM by 35 CM and 35 CM | 50 CM by 35 CM |
| 50.35.35 | | and 35 CM |
| Main Red 65.40.40 | Red Physio Roll 65 CM by 40 CM and 40 CM | 65 CM by 40 CM |
| | | and 40 CM |
| 1 Base cover | A cover made from upholstery made by three pan- | Upholstery Laid flat |
| | els sewn together with 2 zippers to protect the Base | 170 CM × 35 CM |
| | Tube. | |
| Cover Small End | The small end of the cover made from contract | 33 CM diameter cir- |
| | grade durable upholstery with handle and zippered | cle with handle |
| | or velcro opening. | across center and |
| | | semi circle zippered |
| | | opening |
| Cover Large End | The Large end of the cover made from contract | 40 CM diameter |
| | grade durable upholstery with handle and zippered | circle with handle |
| | or velcro opening. | across center and |
| | | semi circle zippered |
| | | opening |
| G20 Cover | An Extra Small Size Cover made from upholstery | 110 CM × |
| | with 1 Cover Large End and 1 Cover Small End | 108 CM × 30 CM |
| | | 32 CM diameter end |
| | | 40 CM diameter end |
| B25 Cover | Small Size Cover | 110 CM × |
| | | 108 CM × 35 CM |
| | | 32 CM diameter end |
| | | 40 CM diameter end |
| P35 Cover | Petit Size Cover | 115 CM × |
| | | 130 CM × 37 CM |
| | | 32 CM diameter end |
| | | 40 CM diameter end |
| B50 Cover | Regular Size Cover | 115 CM × |
| | | 130 CM × 57 CM |
| | | 32 CM diameter end |
| | | 40 CM diameter end |
| R65 Cover | Large Size Cover | 115 CM × |
| | | 130 CM × 68 CM |
| | | 32 CM diameter end |
| | | 40 CM diameter end |
| R65 + 1 Cover | Larger Size Cover | 115 CM × |
| | | 130 CM × 76 CM |
| | | 32 CM diameter end |
| | | 40 CM diameter end |
| R65 + 2 Cover | Largest Size Cover | 115 CM × |
| | | 130 CM × 84 CM |
| | | 32 CM diameter end |
| | | 40 CM diameter end |
| 1 Base | 1 Base: | Upholstery Laid flat |
| | Base tube cover (3 panels 2 zippers) × 1 | 170 CM × 35 CM |
| | Base Tube 1 (Inflatable Inner Tube 135/145 TR13) | 53 CM Diameter 1; |
| | | 10 CM Diameter 2 |
| B20 | B20 | 110 CM × |
| | The B20 is a cover surrounding the Small Tube | 108 CM × 30 CM |
| | 3.5-6× supporting the Blue 20 CM diameter Sphere | 32 CM diameter end |
| | beneath one Medium Tube 400 × 8.00, each end of | 40 CM diameter end |
| | the cover has a handle and an opening sealable via | |
| | velcro or zipper. | |
| G25 | G25 | 110 CM × |
| | The G25 is a cover surrounding the Small Tube | 108 CM × 35 CM |
| | 3.5-6× supporting the Green 25 CM diameter Sphere | 32 CM diameter end |
| | beneath one Medium Tube 400 × 8.00 each end of | 40 CM diameter end |
| | the cover has a handle and an opening sealable via | |
| | velcro or zipper. | |
| P35 | P35 | 115 CM × |
| | The P35 is a cover surrounding the Small Tube | 130 CM × 37 CM |
| | 3.5-6× supporting the Pink 35 CM Diameter Sphere | 32 CM diameter end |
| | beneath one Medium Tube 400 × 8.00 surrounded | 40 CM diameter end |
| | by a cover, each end of the cover has a handle and | |
| | an opening sealable via velcro or zipper. | |
| P35 + 1 | P35 + 1 | 115 CM × |
| | The P35 is a cover surrounding the Small Tube | 130 CM × 42 CM |
| | 3.5-6× supporting the Pink 35 CM Diameter Sphere | 32 CM diameter end |
| | beneath two Medium Tube 400 × 8.00 surrounded | 40 CM diameter end |
| | by a cover, each end of the cover has a handle and | |
| | an opening sealable via velcro or zipper. | |
| B50 | B50 | 115 CM × |
| | The B50 is a base tube with regular cover support- | 130 CM × 57 CM |
| | ing a cover surrounding one Small Tube 3.5-6× | 32 CM diameter end |
| | supporting the Red 65 CM Physio Roll beneath 1 | 40 CM diameter end |
| | Medium Tube 400 × 8.00, each end of the cover | 53 CM Base |
| | has a handle and an opening sealable via velcro or | |
| | zipper. | |
| R65 | R65 | 115 CM × |
| | The R65 is a base tube with cover supporting the | 130 CM × 68 CM |
| | Large cover size of this design surrounding one | 32 CM diameter end |
| | Small Tube 3.5-6× supporting the Red 65 CM | 40 CM diameter end |
| | Physio Roll beneath one Medium Tube 400 × 8.00, | 53 CM Base diame- |
| | each end of the cover has a handle and an opening | ter |
| | sealable via velcro or zipper. | |
| R65 + 1 | R65 + 1 | 115 CM × |
| | The R65 + 1 is a base tube with cover supporting | 130 CM × 76 CM |
| | the second largest cover of this design, surrounding | 32 CM diameter end |
| | a Small Tube 3.5-6× which is supporting the Red | 40 CM diameter end |
| | 65 CM Physio Roll beneath two Medium Tubes 400 × | |
| | 8.00, each end of the cover has a handle and an | |
| | opening sealable via velcro or zipper. | |
| R65 + 2 | R65 + 2 | 115 CM × |
| | The R65 + 2 is a base tube with cover supporting | 130 CM × 84 CM |
| | the largest cover surrounding the Small Tube | 32 CM diameter end |
| | 3.5-6× which is supporting the Red 65 CM Physio Roll | 40 CM diameter end |
| | beneath three Medium Tubes 400 × 8.00, each end | |
| | of the cover has a handle and an opening sealable | |
| | via velcro or zipper. | |
| Design 16 | Design 16 is a cover with handles and openings | |
| | controlled by zippers or velcro at each end. | |
| | Inside the cover is a inflatable rubber tyre inner | |
| | tube 4.00 × 8 (D1 32 d2 8 ) supporting either a | |
| | Blue 50 Physio Roll (50 CM by 35 CM and 35 | |
| | CM ) or Red 65 physio roll (65 CM by 40 CM | |
| | and 40 CM) or 20 CM, 25 CM 35 CM diameter | |
| | spheres supporting another inflatable rubber | |
| | tyre inner tube 4.00 × 8 (D1 32 d2 8 ). | |
| Design 19 | Design 19 is a cover with handles and openings | |
| | controlled by zippers or velcro at each end. | |
| | Inside the cover is a inflatable rubber tyre inner | |
| | tube 135/145 TR13 supporting 20 CM, 25 | |
| | CM35 CM, 50 CM,, 60 CM, 70 CM, and 80 | |
| | CM diameter spheres supporting another inflat- | |
| | able rubber tyre inner tube 4.00 × 8 (D1 32 d2 | |
| | 8). | |
| Seating Or Reclining | 4MM Foam to firm and smooth appearance | Mimic dimen- |
| Device of the inven- | mimic cover dimensions, end pieces have a | sions of adjacent |
| tion 4MM Foam wall | hole large for a hand and pump valve to pass | components |
| and ends | through as if to mimic the dimensions of the | |
| | end inner tube. | |
| FMCG Gathering | Inflatable device comprising body with foldable | Un-inflated flat |
| | head portion and rectangular base portion. | length 126 cm. |
| | | Body - 40 cm di- |
| | | ameter |
| | | Optimum working |
| | | height from base to |
| | | head portion in the |
| | | range 35 cm to 87 |
| | | cm. |
| | | Base dimensions |
| | | 44 cm × 23 cm |
| FMCG Triangle | Inflatable device comprising body with foldable | Un-inflated flat |
| | head portion and triangular base portion. | length 126 cm. |
| | | Body - 40 cm di- |
| | | ameter |
| | | 40 cm diameter |
| | | Optimum working |
| | | height from base to |
| | | head portion in the |
| | | range 35 cm to 87 |
| | | cm. |
| | | Base dimensions - |
| | | equilateral triangle |
| | | of side length 35 cm |
| FMCG 4.4 | Inflatable device comprising multiple air chambers | Fully inflated height |
| | | 110 to 115 cm |
| | | Base dimensions |
| | | 25 × 43 cm |

Referring now to the drawings and specifically FIGS. 1 to 13 inclusive and initially FIG. 1, there is shown a number of preferred portions of a device of the invention. Specifically, there is shown a tube T of the device of the invention, a body portion B of the device of the invention which is spherically, and an alternative body portion B′ of the device of the invention which is dumbbell shaped. Tube T has centrally located orifice O, which has an internally or orifice diameter d_{O} and a tube diameter d_{T} (at the widest point). Body portion B has a diameter d_{B} (at the widest point), whereas dumbbell shaped body portion B′ of the device of the invention has a diameter d_{B} (at the widest point).

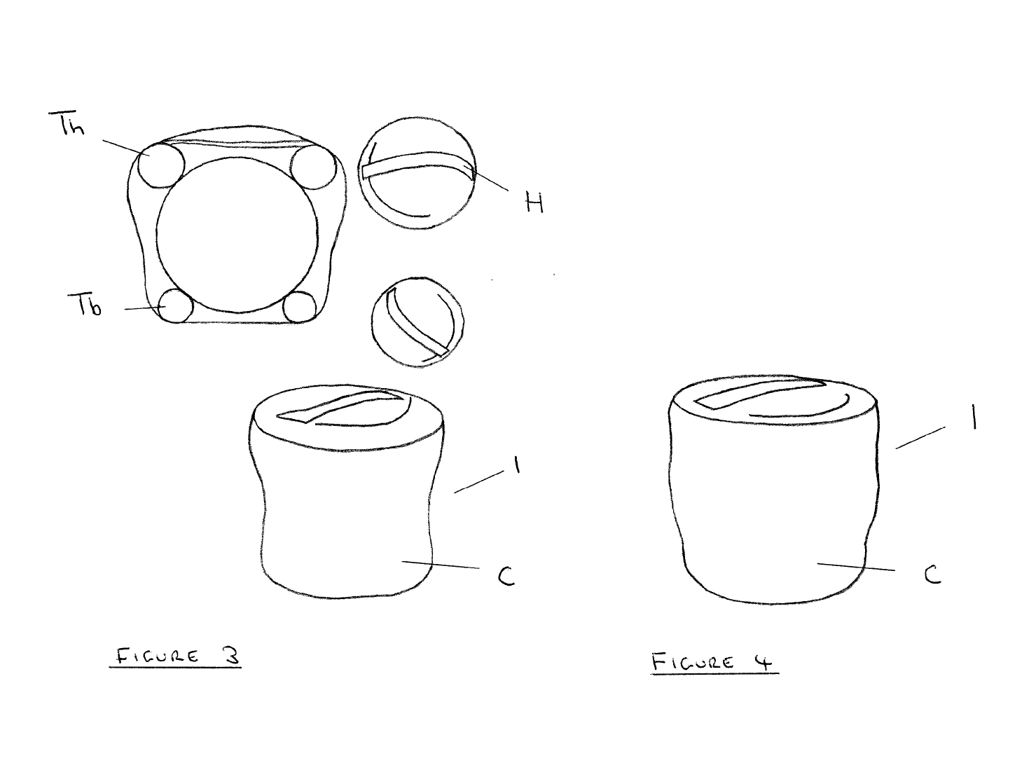

FIG. 2 illustrates the assembled portions of a preferred embodiment of a device 1 of invention, wherein tube T forms the basis for base ring T_{b} and head ring Tₕ, as indicated in the first embodiment of the device 1 invention as shown in FIG. 2, and in the section drawing through line A-A of the perspective view of the device 1. Both of the base ring T_{b} and the head rings Tₕ has an orifice (not shown) located centrally in the respective ring. Handle H is shown in FIG. 2, wherein it is attached to the top and bottom portion of the device 1, whereby the handle H is attached onto cover C which encapsulates the device 1. In the embodiment of device 1 shown FIG. 2, the base ring T_{b} has a smaller diameter than the head ring Tₕ. Body portion B is a sphere wherein the diameter of the sphere forming body B is greater than the diameter of the diameter of the orifice of both base T_{b} and head Tₕ rings, so that the body B rests comfortably within each orifice of the base T_{b} and head Tₕ rings. The user sits on the top portion S. The profile of the device arises from the combination of a smaller base T_{b} ring with a larger head Tₕ ring.

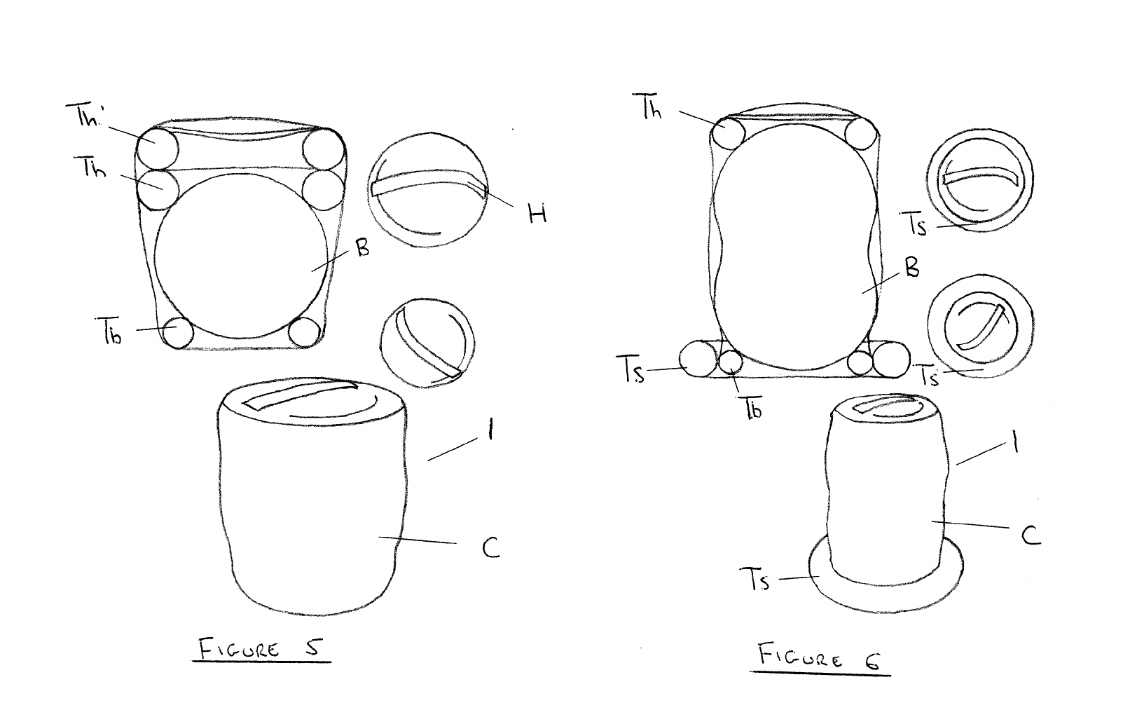

FIG. 3 is a large version of the embodiment shown in FIG. 2.

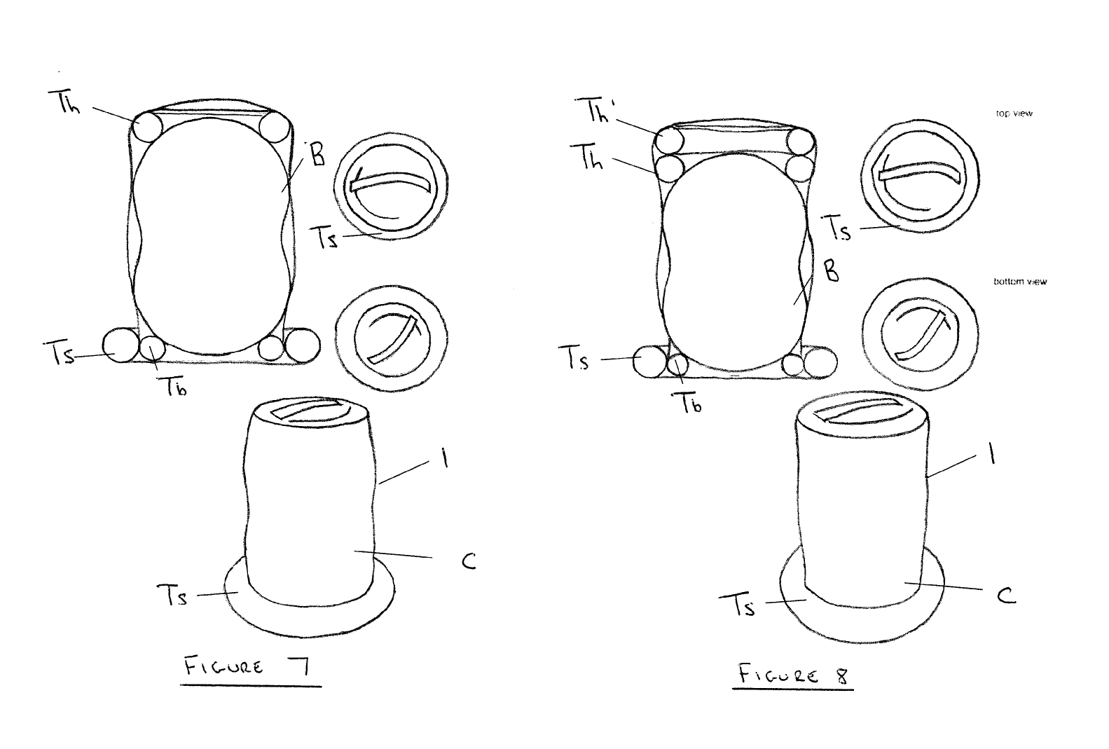

FIG. 4 shows a similar embodiment to that of FIGS. 2 and 3, however, in this particular embodiment, the base ring T_{b} has a diameter the same as the head ring Tₕ. Body portion B is a sphere wherein the diameter of the sphere forming body B is greater than the diameter of the orifice of both base T_{b} and head Tₕ rings. The user sits on the top portion S. The effect of this arrangement of the portions is that aesthetically the device 1 appears as shown in FIG. 4

FIG. 5 shows a related embodiment to that of FIG. 4, wherein a second head Tₕ′ ring is provided over the first head ring Tₕ. The effect is that the seating area provided by the head rings is higher than the embodiment shown in FIG. 4. This embodiment is particularly suited to taller users.

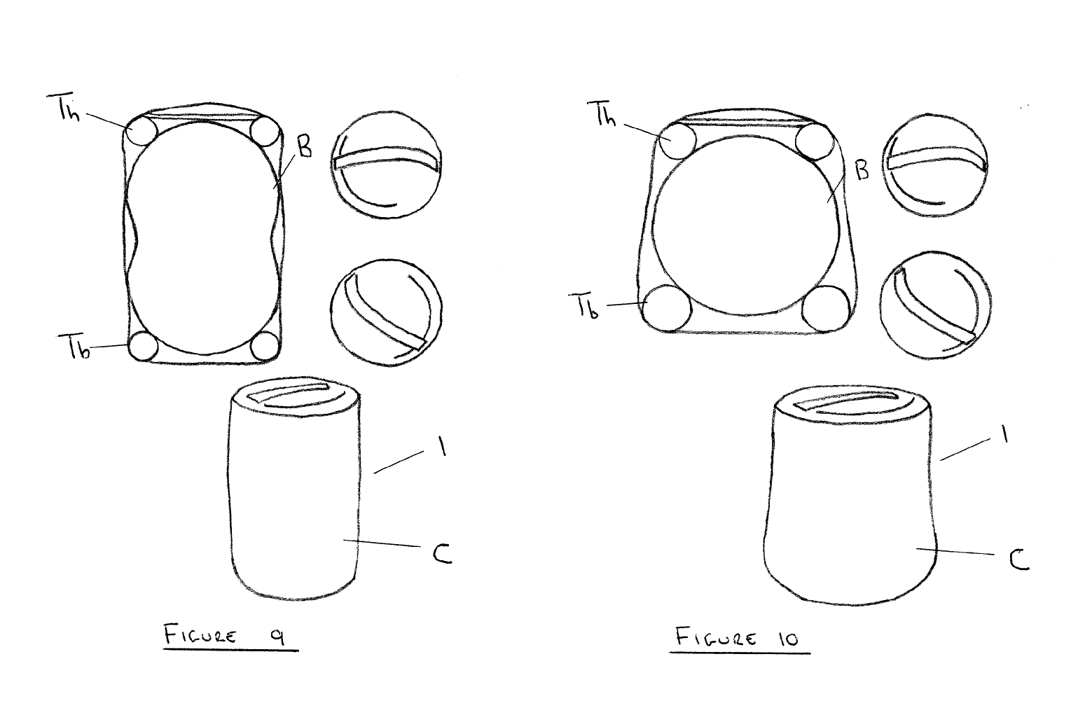

FIG. 6 shows a further preferred embodiment of the device 1 of the invention. In this embodiment, the body B is dumbbell shaped. Head ring Tₕ and base ring T_{b} are the equal in size. A stabilizing base Tₛ, is provided in this embodiment. The device 1 is encapsulated by cover C, HI and is inserted into orifice of the stabilizing base Tₛ, to provide a more stable arrangement. The stabilizing base Tₛ can be seen in the top and bottom view of the device shown in FIG. 6. The perspective view of the device 1 shown in FIG. 6 gives an indication of the profile of this particular embodiment of the invention. This embodiment is particularly suited to taller users whom might require more stability. Dumbbell shaped body B provides the aesthetic profile shown in FIG. 6.

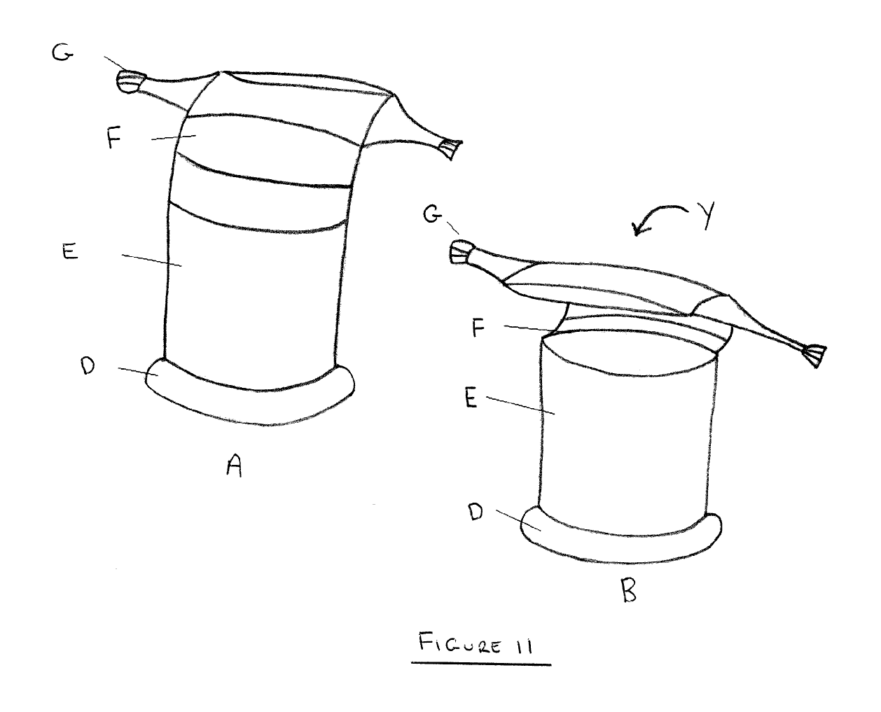

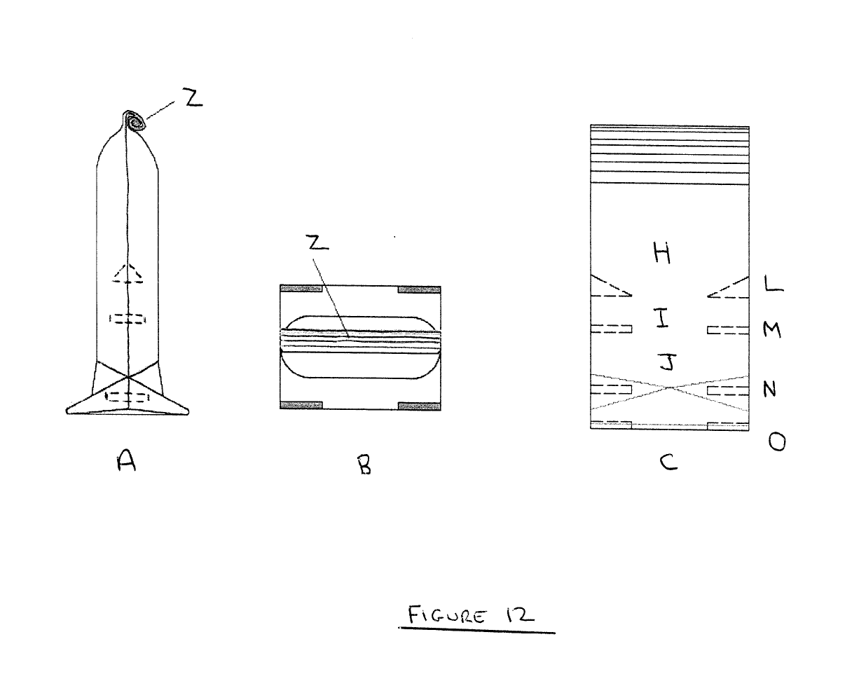

FIG. 7 shows an embodiment similar to that of FIG. 6 and using a dumbbell shaped body B. This embodiment also includes the stabilizing base Tₛ. FIG. 8 is an embodiment of the device 1 similar to that of FIG. 7 wherein an additional second head Tₕ′ ring is provided.

FIG. 9 is a further embodiment of the device 1.

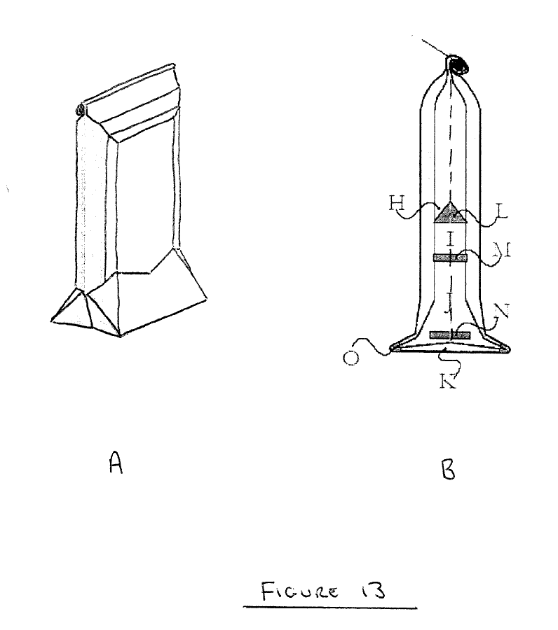

FIG. 10 is a further still embodiment of the device of FIG. 4 wherein the device shown in FIG. 4 is inverted so that the base is wider that the seat area S.

In use, a user must approach and mount the device 1 of the invention and sit on seat area S, find balance by aligning their center of gravity with that of the device 1 while ensuring the trunk to thigh angle is greater than 90 degrees, which causes the users to find their bodies fall into correct posture which allows the full abdomen to move and the lungs to reach optimum capacity, which fosters a non stressed muscle system while optimizing the users' neurological system. The devices can be mounted and sat and laid upon on all sides facilitating other motions and rest dynamisms. The devices can be laid horizontally and users can lay on their back, belly or posterior to facilitate different stretching and rests.

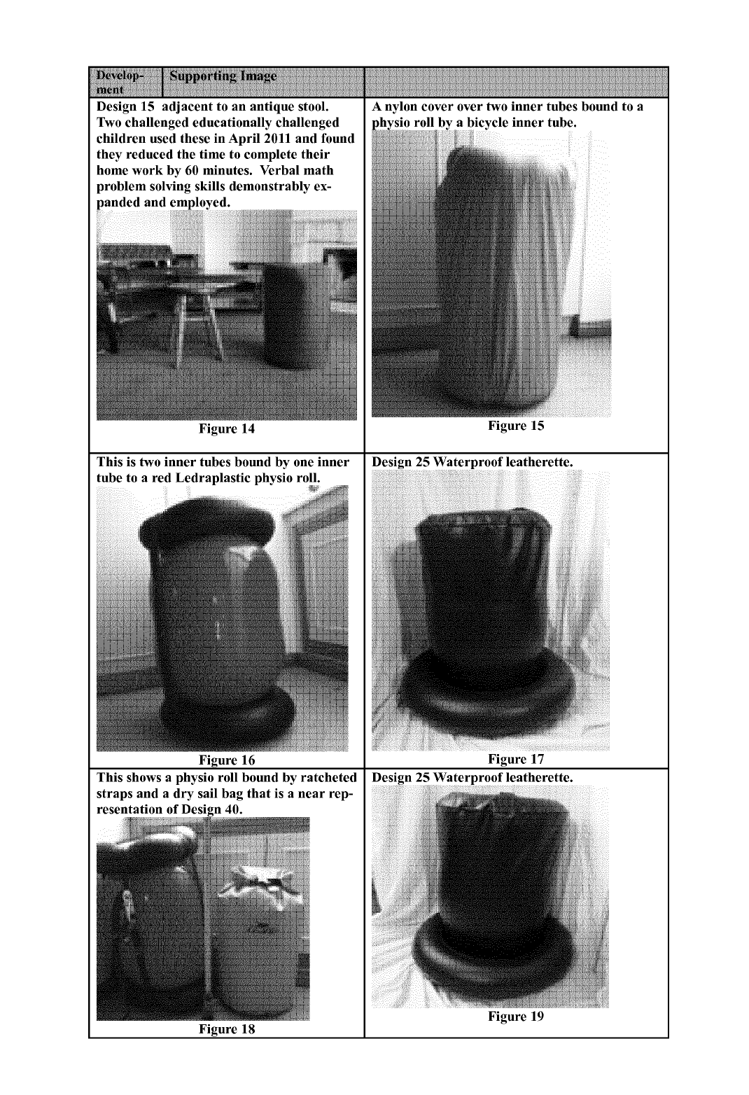

FIGS. 11 A and B show an embodiment of a device according to another aspect of the invention comprising a base D, body E and a foldable head portion F. In use, the device is inflated via a connector G on the head portion. When unfolded, the head portion projects upright from the body portion (FIG. 11A). The head portion is foldable downwards towards the base of the device, such that successive folds of the head portion reduce the overall height of the device. The foldable section may be folded to reduce the device to a desired height for seating (See for example, folding in the direction Y of FIG. 1B).

Folding the head portion reduces the internal volume of the device thus increasing the pressure on the fluid used for inflation, for example, air. In this manner, the overall rigidity of the device can be adjusted by the user in order to suit their preference.

The device is preferably dimensioned to be portable and easily transported by a user. In one embodiment, the deflated device weighs about 1 kilogram. In a fully deflated configuration, the device is about 500 ml or less in volume. This allows the device to be fitted into a typically sized carrier bag or back pack or into a typically sized pocket on a garment such as a coat.

The device is preferably fabricated from a single sheet of airtight material that is folded and fused to form the base, body and head portions. The airtight material may be PET, Plastic, nylon, Rip Stop Nylon or PVC Silnylon. The base may be one of a variety of shapes. The base may be rectangular shaped or the base may be triangular shaped. In an alternative embodiment, the base, body and head portion may have separating layers and be inflatable separately via separate values or connectors.

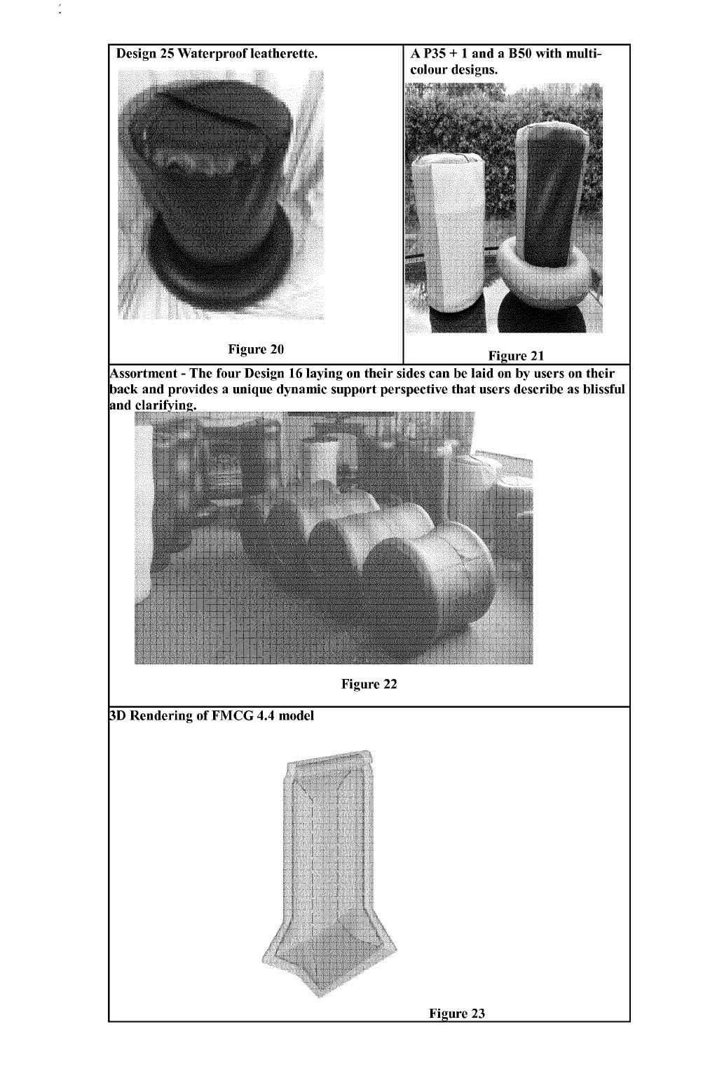

FIGS. 12 and 13 show a further embodiment of the device. Once again, the device is preferably dimensioned to be portable and easily transported by a user. The device comprises a number of inflatable chambers; an internal bulk chamber and further comprising a plurality of chambers formed by fused walls and partial barricades or restrictions to the chambers. The barricades are complete once the device is inflated and bearing weight. The open end of the device comprises three openings. The bulk air chamber has one opening. The open end further comprises two openings to the multiple air chamber network. This is analogous to the shape of a multi hull ship whereas the exterior layer of air tight material is flat and acts as a shield to the internal ballast chambers, which are protected by an internal layer.

In the FMCG 4.4 (known as AerChair Lite 5) layer embodiment depicted in FIGS. 12 and 13, an exterior layer is fused to the exterior wall of the plurality or network of air chambers. Air may flow through the network of air chambers when not bearing weight or not inflated. When the network of chambers are inflated and bearing weight, the walls of the exterior layer and the wall of the network of air chambers press together restricting the flow between the chambers. The network of chambers in this example are symmetrical in design but due to flexibility of different materials the chambers and the barricades that form their foundations may be asymmetrical or symmetrical. If the device is rolled or folded, it needs to be unrolled or unfolded to be inflated. Unrolling causes the openings of the chambers to open. With the openings to the multiple air chambers open, while keeping the bulk air chamber opening closed, the user lifts or sweeps the device to fill the network of chambers then rolls the openings closed driving the air to fill the network of chambers. Then, the user opens the chambers again but this time opens the bulk air chamber completely, closes the openings to the network of chambers and then with a similar motion of raising or sweeping, the bulk chamber is filled with air and the user rolls or folds the device at the point Z to the desired height and rigidity.

When the device is filled, closed and bearing weight (i.e. when the device is being sat on by a user) the walls are pressed together forming separate regions of a base K, body J and head I of the motional chair. The symmetrical network of chambers should be considered as two layers of air tight materials with partial barricades (L, M, N) formed by fusing the walls together in a pattern of a funnel H to a narrow channel (between area H and I).

A nearly rectangular head region I is barricaded by the fused walls L and M. The device further comprises a larger body region J further bound by partial barricades M and N to form a nearly rectangular region. A base region K is bounded by base corner partial barricades O and by partial barricades N.

The bulk chamber exterior can be folded downwards at point Z to the height and air pressure as desired by the user. In this manner, dynamic seating or reclining support is afforded to the user.

The device is preferably fabricated from a single sheet of airtight material that is folded and fused to form the device. The airtight material may be PET, Plastic, nylon, Rip Stop Nylon or PVC Silnylon. An exterior layer may be fitted around the device. The exterior layer may be fabricated from Nylon or Hemp fused with PVC.

The device is preferably dimensioned to be portable and easily transported by a user. In one embodiment, the deflated device weighs about 1 kilogram. In a fully deflated configuration, the device is about 500 ml or less in volume. This allows the device to be fitted into a typically sized carrier bag or back pack or into a typically sized pocket on a garment such as a coat.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The invention is not limited to the embodiments hereinbefore described but may be varied in both construction and detail.

1. A device suitable for sitting or reclining, the device comprising:
a base portion having upper and lower surfaces and at least one depression which extends into at least the upper surface of the base thereof; and
a body portion having at least one surface region adapted to be received within the depression of the base;
wherein the diameter of the body is greater than the diameter of the depression, such that the body projects beyond at least the upper surface of the base, such that the body is supported by the base.

2. The device of claim 1 further comprising a head portion having upper and lower surfaces and at least one depression which extends into at least the lower surface of the head thereof;
wherein the body portion has at least one second surface region adapted to be received within the depression of the head; and
wherein the diameter of the body is greater than the diameter of the depression, such that the body projects beyond at least the lower surface of the head, such that the head is supported by the body.

3. The device of claim 2 further comprising means for limiting relative movement of the base, body and head portions, wherein the means comprises a strap or band secured about the head and base portions of the device to hold the portions in close contact, or a cover for encapsulating the device.

4. The device of claim 3 further comprising a stabilizing base having an orifice located therein for accommodating the device, wherein the diameter of the device is substantially the same as the diameter of the orifice of the stabilizing base.

5. The device of claim 4 wherein the base is circular or cylindrical ring shaped, square ring shaped, triangular ring shaped or serpentine ring shaped, pipe shaped ring or a tubular shaped ring and the body is sphere shaped, dumbbell shaped, square shaped, pyramid shaped, circular or cylindrical ring shaped, square ring shaped, triangular ring shaped or serpentine ring shaped.

6. The device of claim 5 wherein the base may be circular or cylindrical ring shaped, square ring shaped, triangular ring shaped or serpentine ring shaped, a pipe shaped ring or a tubular shaped ring and the body is sphere shaped, dumbbell shaped, square shaped, pyramid shaped, circular or cylindrical ring shaped, square ring shaped, triangular ring shaped or serpentine ring shaped and the head is circular or cylindrical ring shaped, square ring shaped, triangular ring shaped, elliptical ring shaped, pipe or tubular shaped.

7. The device of claim 2 wherein the depression is a groove or is groove shaped to provide an indentation into the base or head portion of the device or the depression extends through the upper and lower surfaces of the base to form an orifice therein.

8. The device of claim 2 wherein the head, base and/or body are made of an elastic material and at least one of the base, head and/or body is hollow.

9. The device of claim 8 wherein at least one of the hollow head, base and/or body is inflatable and comprises a valve means for inflation.

10. The device of claim 1 further comprising at least one handle.

11. The device of claim 1, wherein two or more devices are arranged on their sides in row to greater surface area for reclining.

12. A process for manufacturing a device suitable for seating or reclining, the process comprising:
providing a base portion having upper and lower surfaces and at least one depression which extends into at least the upper surface of the base thereof; and
supporting a body portion onto the base portion,
wherein the body portion has at least one surface region adapted to be received within the depression of the base, wherein the diameter of the body is greater than the diameter of the depression, such that the body projects beyond at least the upper surface of the base, such that the body is supported by the base.

13. The process of claim 12 further comprising the step of;
supporting a head portion onto the body portion, wherein the head portion has upper and lower surfaces and at least one depression which extends into at least the lower surface of the head thereof; and the body portion having at least one second surface region adapted to be received within the depression of the head, wherein the diameter of the body is greater than the diameter of the depression, such that the body projects beyond at least the lower surface of the head, such that the head is supported by the body; and,
the optional step of encapsulating the device with a cover or securing the portions together using a strap.

14. (canceled)

15. (canceled)

16. A device suitable for sitting or reclining, the device comprising;
an inflatable head, body and base portion;
such that when the device is inflated, the head portion is further foldable in the direction of the base to reduce the vertical dimension of the device.

17. The device of claim 16, wherein the head, body and base portion are integrally formed.

18. The device of claim 16, wherein the head, body and base portion are formed from a single piece of air tight material.

19. The device of claim 16 wherein the head, body and base portions comprise a plurality of interconnected chambers.

20. The device of claim 16 wherein when the device is uninflated, the device is dimensioned to be 500 ml or less in volume.

21. The device of claim 1, further comprising:
a head portion having upper and lower surfaces and at least one depression Which extends into at least the lower surface of the head portion;
wherein the body portion has at least one second surface region adapted to be received within the depression of the head; and
wherein the diameter of the body is greater than the diameter of the depression in the base portion, such that the body projects beyond at least the upper surface of the base portion, such that the body is supported by the base portion, and
wherein the diameter of the body is greater than the diameter of the depression in the head portion, such that the body projects beyond at least the lower surface of the head portion, such that the head portion is supported by the body.
